(19) United States
(12) Patent Application Publication
(10) Pub. No.: US 2020/0059000 A1
(43) Pub. Date: Feb. 20, 2020

(54) ANTENNA ARRAY

(71) Applicants: Nidec Corporation, Kyoto (JP); WGR Co., Ltd., Kyoto-City (JP)

(72) Inventors: Hiroyuki KAMO, Kyoto (JP); Yosuke SATO, Kyoto (JP); Hideki KIRINO, Kyoto-city (JP)

(21) Appl. No.: 16/543,853

(22) Filed: Aug. 19, 2019

(30) Foreign Application Priority Data
Aug. 20, 2018 (JP) 2018-153879

(51) Int. Cl. H01Q 13/02; H01Q 21/00; H01Q 21/06

(52) U.S. Cl. CPC H01Q 13/0275; H01Q 21/064; H01Q 21/0068

(57) ABSTRACT

An antenna array includes a first conductor, a second conductor, waveguiding walls, and conductive rods. The waveguiding walls and the conductive rods are disposed between the first and second conductors. The first conductor includes hollows respectively defining horns each defining and functioning as an antenna element. Each hollow opens in the first conductive surface and in the second conductive surface. The second conductor includes through holes that overlap the hollows. On the inner surface of each through hole, a core wire of the coaxial cable, or another electrical conductor that is connected to the core wire, is connected. Each waveguiding wall surrounds at least a portion of a space between one of hollows and one of the through holes. The conductive rods are located around the waveguiding walls.

### CROSS REFERENCE TO RELATED APPLICATION

The present invention claims priority under 35 U.S.C. § 119 to Japanese Application No. 2018-153879 filed on Aug. 20, 2018, the entire contents of which are incorporated herein by reference.

### 1. FIELD OF THE INVENTION

The present disclosure relates to an antenna array having a plurality of horns.

### 2. BACKGROUND

Antenna arrays which are capable of inputting or outputting independent signals to respective ones of a plurality of antenna elements may be useful in a broad range of fields, such as sensing (e.g., radars) and wireless communications. Among others, antenna arrays having a plurality of horns as antenna elements would be particularly useful because of their broad frequency bands and small losses. Examples of such horn antenna arrays are disclosed in U.S. Pat. Nos. 4,115,782, 6,271,799 and U.S. Patent Publication No. 2005-0253770 listed below, for example.

Each horn in a horn antenna array can be fed by a hollow waveguide or a coaxial cable. However, for feeding with a hollow waveguide, a complicated network of hollow waveguides would be required. On the other hand, for feeding with a coaxial cable, each horn would need a waveguide-to-coaxial adapter, also resulting in a complicated structure. Regardless of which construction is chosen, it is difficult to closely place a plurality of horns to constitute the array, which hinders downsizing of the antenna array. In the case where a phased array is to be constructed with a plurality of antenna elements, grating lobes will appear in the visible region of the antenna if the interval between antenna elements is greater than a half of the wavelength of the electromagnetic wave used. The occurrence of grating lobes will cause radar misdetection, or deteriorate the efficiency of the communication antenna. In the case where a phased array is constructed with a plurality of horn antenna elements, it has been impossible to increase the range of angles in which beam scanning can be achieved without being affected by grating lobes.

On the other hand, U.S. Patent Publication No. 2018/0301817, U.S. Patent Publication No. 2018/0113187 and U.S. Patent Publication No. 2019/0123411 disclose examples of structures for transmitting signal waves among a plurality of electrically conductive members having through holes to function as waveguides.

### SUMMARY

Example embodiments of the present disclosure provide antenna arrays each of which allows a plurality of horn antenna elements to be closely arranged relative to each other.

An antenna array according to an example embodiment of the present disclosure includes a first electrical conductor, a second electrical conductor, a plurality of waveguiding walls, and a plurality of electrically conductive rods. The first electrical conductor includes a first electrically conductive surface at a front side, a second electrically conductive surface at a rear side, and a plurality of hollows respectively defining a plurality of horns each defining and functioning as an antenna element. Each of the plurality of hollows opens in the first electrically conductive surface and in the second electrically conductive surface. The plurality of horns include three or more horns that are arrayed along a first direction and along a second direction, the first direction and the second direction intersecting each other. The second electrically conductor includes a third electrically conductive surface opposing the second electrically conductive surface and a plurality of through holes. The plurality of through holes respectively overlap the plurality of hollows when seen through in a third direction which is orthogonal to both of the first direction and the second direction. An inner surface of each of the plurality of through holes includes a junction at which a core wire of a coaxial cable or another electrical conductor that is connected to the core wire is connected. The plurality of waveguiding walls are located between the second electrically conductive surface and the third electrically conductive surface. Each waveguiding wall surrounds at least a portion of a space between one of the plurality of hollows and one of the plurality of through holes. Each electrically conductive rod includes a root that is connected to one of the second electrically conductive surface and the third electrically conductive surface and a leading end that is opposed to another of the second electrically conductive surface and the third electrically conductive surface. The plurality of electrically conductive rods are located around the plurality of waveguiding walls.

According to each of example embodiments of the present disclosure, a plurality of horn antenna elements are able to be closely arranged relative to each other.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1A is a perspective view showing an antenna array according to an illustrative first example embodiment of the present disclosure.

FIG. 1B is a perspective view showing the antenna array as viewed from another angle.

FIG. 2A is a perspective view showing a first conductive member.

FIG. 2B is a front view showing the first conductive member.

FIG. 2C is a perspective view in which a horn is shown enlarged.

FIG. 2D is a diagram showing the aperture shape of the through hole of each horn.

FIG. 3A is a diagram showing a structure remaining after removing the first conductive member from the antenna array.

FIG. 3B is a diagram showing a structure remaining after removing a coaxial cable 340 from the structure shown in FIG. 3A.

FIG. 3C is a diagram in which a through hole 325 in a second conductive member is shown enlarged.

FIG. 3D is a diagram showing the aperture shape of a through hole in the second conductive member.

FIG. 4 is a perspective view showing the structure on the rear side of the first conductive member.

FIG. 5 is a side view of an antenna array.

FIG. 6 is a cross-sectional view of the antenna array in FIG. 5 as taken along line A-A′.

FIG. 7 is a cross-sectional view of the antenna array in FIG. 6 as taken along line B-B′

FIG. 8A is a cross-sectional view of an antenna array according to a variant of the first example embodiment of the present disclosure.

FIG. 8B is a cross-sectional view of an antenna array according to another variant of the first example embodiment of the present disclosure.

FIG. 8C is a cross-sectional view of an antenna array according to still another variant of the first example embodiment of the present disclosure.

FIG. 9 is a schematic diagram showing the second conductive member 320 according to the variant of FIG. 8C as viewed from the rear side.

FIG. 10 is a diagram schematically showing an exemplary construction of a communication system that includes an antenna array and a communications device.

FIG. 11A is a diagram showing a variant of the cross-sectional structure shown in FIG. 6.

FIG. 11B is a diagram showing another variant of the cross-sectional structure shown in FIG. 6.

FIG. 12 is a diagram showing the structure of a cross section of an antenna array according to a second example embodiment of the present disclosure as taken in parallel to the XY plane.

FIG. 13A is a perspective view showing a horn array according to the second example embodiment of the present disclosure.

FIG. 13B is a plan view showing the horn array according to the second example embodiment of the present disclosure.

FIG. 14A is a diagram showing the structure of a cross section of an antenna array according to a variant of the second example embodiment of the present disclosure as taken in parallel to the XY plane.

FIG. 14B is a diagram showing the structure of a cross section of an antenna array according to another variant of the second example embodiment of the present disclosure as taken in parallel to the XY plane.

FIG. 15 is a diagram showing the structure of a cross section of an antenna array according to a third example embodiment of the present disclosure as taken in parallel to the XY plane.

FIG. 16 is a diagram showing the structure of a cross section of an antenna array according to a fourth example embodiment of the present disclosure as taken in parallel to the XY plane.

FIG. 17A is a perspective view showing a horn array according to a fourth example embodiment of the present disclosure.

FIG. 17B is a front view showing the horn array according to the fourth example embodiment of the present disclosure.

FIG. 18 is a diagram for describing examples of through holes.

FIG. 19A is a diagram showing an exemplary range of dimension of each member in the waffle iron structure.

FIG. 19B is a diagram showing a variant of conductive rods.

### DETAILED DESCRIPTION

An antenna array according to an illustrative example embodiment of the present disclosure includes a first electrically conductive member, a second electrically conductive member, a plurality of waveguiding walls, and a plurality of electrically conductive rods. The first electrically conductive member includes a first electrically conductive surface at the front side, a second electrically conductive surface at the rear side, and a plurality of hollows respectively defining a plurality of horns each functioning as an antenna element. Each of the plurality of hollows opens in the first electrically conductive surface and in the second electrically conductive surface. The plurality of horns include three or more horns that are arrayed along a first direction and along a second direction, the first direction and the second direction intersecting each other. The second electrically conductive member includes a third electrically conductive surface opposing the second electrically conductive surface and a plurality of through holes. The plurality of through holes respectively overlap the plurality of hollows when seen through in a third direction which is orthogonal to both of the first direction and the second direction. An inner surface of each of the plurality of through holes includes a junction at which a core wire of a coaxial cable or another electrical conductor that is connected to the core wire is connected. The plurality of waveguiding walls are located between the second electrically conductive surface and the third electrically conductive surface. Each waveguiding wall surrounds at least a portion of a space between one of the plurality of hollows and one of the plurality of through holes. Each electrically conductive rod has a root that is connected to one of the second electrically conductive surface and the third electrically conductive surface and a leading end that is opposed to another of the second electrically conductive surface and the third electrically conductive surface. The plurality of electrically conductive rods are located around the plurality of waveguiding walls.

With the above construction, an antenna array in which a plurality of horns are closely placed can be constructed.

The plurality of electrically conductive rods may include an electrically conductive rod that is located away, along a direction which is substantially orthogonal to the first direction, from a center portion of one of the plurality of through holes as viewed along the third direction.

With the above construction, a rod is disposed adjacent to the center portion of a through hole where the electric field is most intense, and thus leakage of electromagnetic waves from where the first electrically conductive member and the second electrically conductive member are jointed can be effectively suppressed.

As viewed along the third direction, the plurality of electrically conductive rods may include an electrically conductive rod that is located between two adjacent through holes adjoining along the second direction among the plurality of through holes.

With the above construction, isolation of signal waves between two adjacent through holes adjoining along the second direction can be improved.

The second direction may or may not be orthogonal to the first direction.

An inner surface of each of the plurality of hollows may include at least one ridge that guides an electromagnetic wave emerging from the coaxial cable into external space. The at least one ridge protrudes from the inner surface of the hollow in a direction intersecting the first direction. In one example embodiment, the direction intersecting the first direction may be a direction substantially orthogonal to the first direction.

The at least one ridge may be a pair of ridges having top faces opposing each other. In other words, the inner surface of each of the plurality of hollows may have a pair of ridges that guide an electromagnetic wave emerging from the coaxial cable into external space. An interval between the pair of ridges may be allowed to enlarge from the rear side toward the front side.

By providing at least one ridge, electromagnetic waves can be radiated more efficiently.

The inner surface of each of the plurality of through holes may include a protrusion. The junction may be located on the protrusion. The core wire or the other electrical conductor may be in contact with the protrusion.

With the above construction, connection between the coaxial cable and each through hole can be facilitated.

An end face, that is closer to the first electrically conductive member, of the protrusion may be opposed to an end face, that is closer to the second electrically conductive member, of one of the at least one ridge.

With the above construction, electromagnetic waves can be transmitted between the protrusion and the ridge(s) with a high efficiency.

The plurality of waveguiding walls may be connected to the second electrically conductive surface. The plurality of electrically conductive rods may be connected to the third electrically conductive surface.

With the above construction, leakage of signal waves can be effectively suppressed.

At least one of the plurality of waveguiding walls may include a recess on an outer peripheral surface facing toward another adjacent waveguiding wall adjoining along the second direction. One of the plurality of electrically conductive rods may adjoin the recess.

With the above construction, the distance between two adjacent horns adjoining along the second direction can be reduced.

Among the plurality of waveguiding walls, a groove may exist between two adjacent waveguiding walls adjoining along the first direction, the groove extending along a direction which is orthogonal to the first direction.

With the above construction, isolation of signal waves between two adjacent horns adjoining along the first direction can be improved.

The antenna array may further comprise a plurality of connectors respectively mounted on the rear side of the plurality of through holes. Each of the plurality of connectors may include an internal conductor having a plug or jack shape, a dielectric outside the internal conductor, and an external conductor outside the dielectric. The internal conductor may be connected to the junction.

With the above construction, connection and detachment between the coaxial cable and the antenna array can be facilitated.

The antenna array may further comprise a plurality of coaxial cables respectively connected to the inner surfaces of the plurality of through holes.

The antenna array may further comprise: a plurality of connectors respectively connected to the inner surfaces of the plurality of through holes; and a plurality of coaxial cables respectively connected to the plurality of connectors.

A communication system according to an example embodiment of the present disclosure comprises: any of the above antenna arrays; and a communications device connected to the plurality of coaxial cables.

Hereinafter, specific exemplary constructions according to example embodiments of the present disclosure will be described. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

### First Example Embodiment

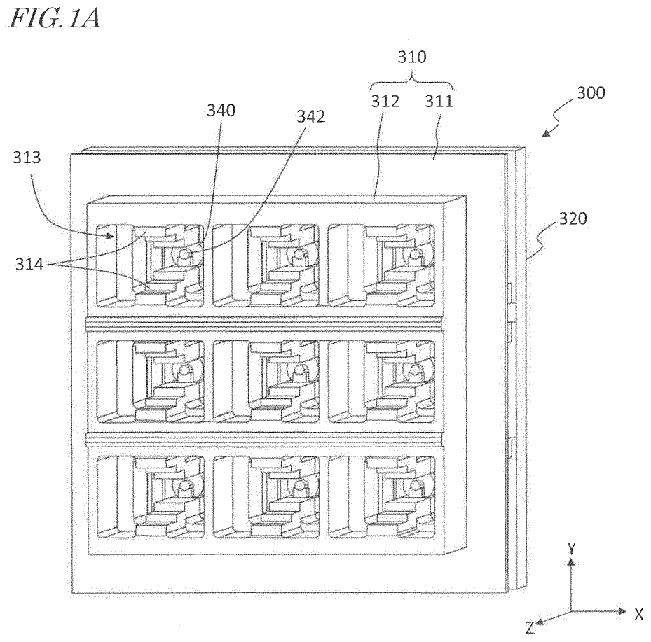

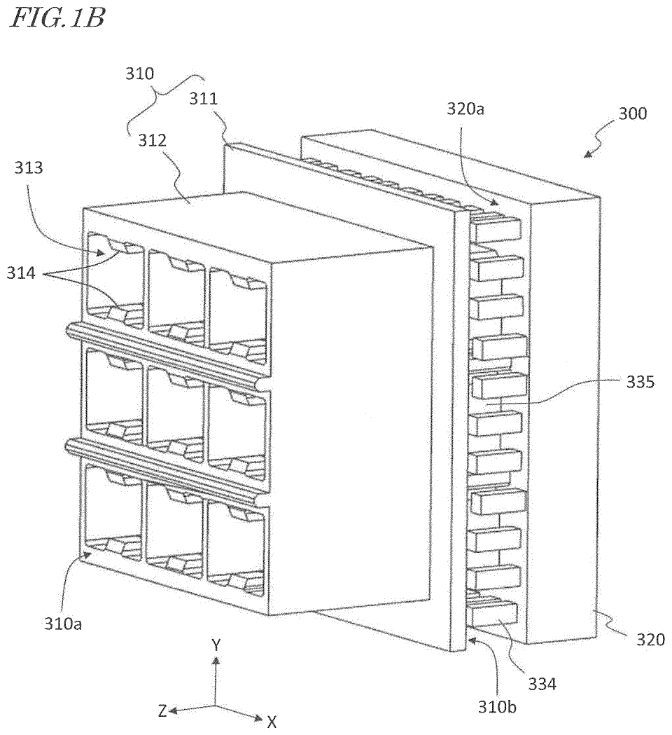

FIG. 1A is a perspective view showing an antenna array 300 according to an illustrative first example embodiment of the present disclosure. FIG. 1B is a perspective view showing the antenna array 300 as viewed from another angle. FIG. 1A and FIG. 1B show XYZ coordinates representing X, Y, and Z directions which are orthogonal to one another. Hereinafter, the construction of the antenna array 300 will be described with reference to this coordinate system. The side in the +Z direction will be referred to as “the front side”, whereas the side in the −Z direction will be referred to as “the rear side”. The “front side” refers to the side toward which an electromagnetic wave is radiated, or at which an electromagnetic wave arrives, whereas the “rear side” is the opposite side to the front side. Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size.

The antenna array 300 includes a first electrically conductive member 310 and a second electrically conductive member 320. The first conductive member 310 includes an array of a plurality of horns 313 each functioning as an antenna element. The second conductive member 320 includes an array of a plurality of waveguide-to-coaxial adapters disposed respectively corresponding to the plurality of horns 313. The plurality of horns 313 and the plurality of waveguide-to-coaxial adapters are arranged in a two dimensional array along a first direction (which in this example is the X direction) and along a second direction (which in this example is the Y direction). In the present example embodiment, the second direction is orthogonal to the first direction. Alternatively, the second direction may intersect the first direction at an angle which is not equal to 90 degrees. FIG. 1A also shows a plurality of coaxial cables 340 that are respectively mounted to the plurality of adapters of the second conductive member 320.

As antenna elements, the antenna array 300 according to the present example embodiment includes nine horns 313, which are arrayed in three rows and three columns. The number of horns 313 may not be nine. For example, the antenna array 300 may be composed of 256 horns 313 arranged in an array of 16 rows by 16 columns. The number and arrangement of plurality of horns 313 may be determined depending on the application and the purpose. The array arrangement of the plurality of horns 313 may not be a simple array of rows and columns.

The first conductive member 310 according to the present example embodiment includes a relatively thin electrically conductive plate 311 and a horn array section 312 disposed on the front side of the electrically conductive plate 311. The horn array section 312 has an outer peripheral wall which is thicker than the electrically conductive plate 311, and a plurality of hollows inside the outer peripheral wall, the plurality of hollows respectively defining the plurality of horns 313. Each hollow defining a horn 313 is structured so that its internal space enlarges from the rear side toward the front side. On its inner surface, each horn 313 includes a pair of ridges 314 opposing each other. Each ridge in the pair of ridges 314 protrudes from the inner surface in Y direction intersecting the first direction (X direction in this example) and extends along a plane which is parallel to the Y direction and the Z direction. The gap between the pair of ridges 314 monotonically increases from the rear side toward the front side. The pair of ridges 314 each present a staircase-like structure, such that their interval enlarges toward the front side. Without being limited to a staircase-like structure, the ridges 314 may be structured so that the interval between them smoothly increases. The hollow inside each horn 313 functions as a hollow waveguide. During transmission, the pair of ridges 314 guide a radio-frequency electromagnetic wave which has occurred from a core wire 342 of the coaxial cable 340, and radiates it into external space.

As shown in FIG. 1B, the first conductive member 310 has a first electrically conductive surface 310a at the front side and a second electrically conductive surface 310b at the rear side. The second conductive member 320 has a third electrically conductive surface 320a at the front side. The third conductive surface 320a is opposed to the second conductive surface 310b. Each of the plurality of hollows defining a horn 313 extends through the first conductive member 310, and opens in the first conductive surface 310a and the second conductive surface 310b. Between the second conductive surface 310b and the third conductive surface 320a, a plurality of electrically conductive rods 334 and a plurality of waveguiding walls 335 are disposed. Each conductive rod 334 has a root that is connected to the third conductive surface 320a and a leading end opposing the second conductive surface 310b. The conductive rods 334 restrain electromagnetic waves that are transmitted from the coaxial cables 340 to the horns 313 from leaking outside. Each conductive rod 334 may alternatively be provided on the second conductive surface 310b. The plurality of waveguiding walls 335 are connected to the second conductive surface 310b. Details of the waveguiding walls 335 will be described later.

The first conductive member 310, the second conductive member 320, the plurality of conductive rods 334, and the plurality of waveguiding walls 335 may each be shaped by machining a metal plate, for example. Each member may be formed by casting, e.g., a die-cast technique. Alternatively, each member may be forming a plating layer on the surface of an electrically-insulative material of e.g., resin. As the electrically conductive material composing each of the conductive members 310 and 320, the rods 334, and the waveguiding walls 335, a metal such as magnesium may be used. Instead of a plating layer, a layer of electrical conductor may be formed by vapor deposition or the like. In the present example embodiment, the first conductive member 310 and each of the plurality of waveguiding walls 335 are parts of a single-piece body, whereas the second conductive member 320 and each of the plurality of rods 334 are parts of another single-piece body. These single-piece bodies may each be integrally fabricated.

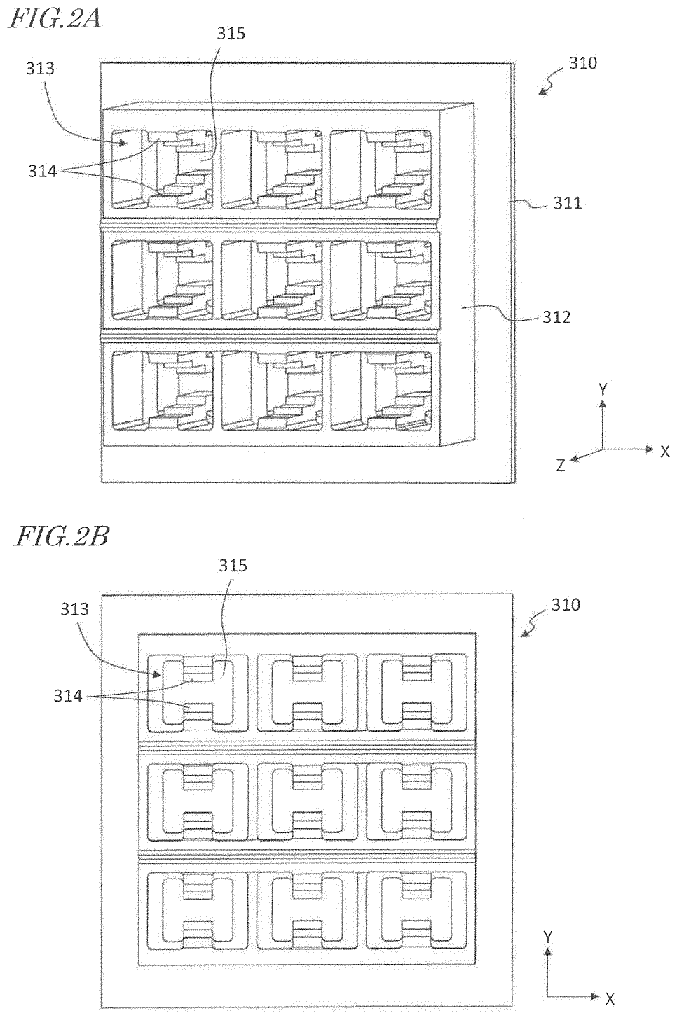

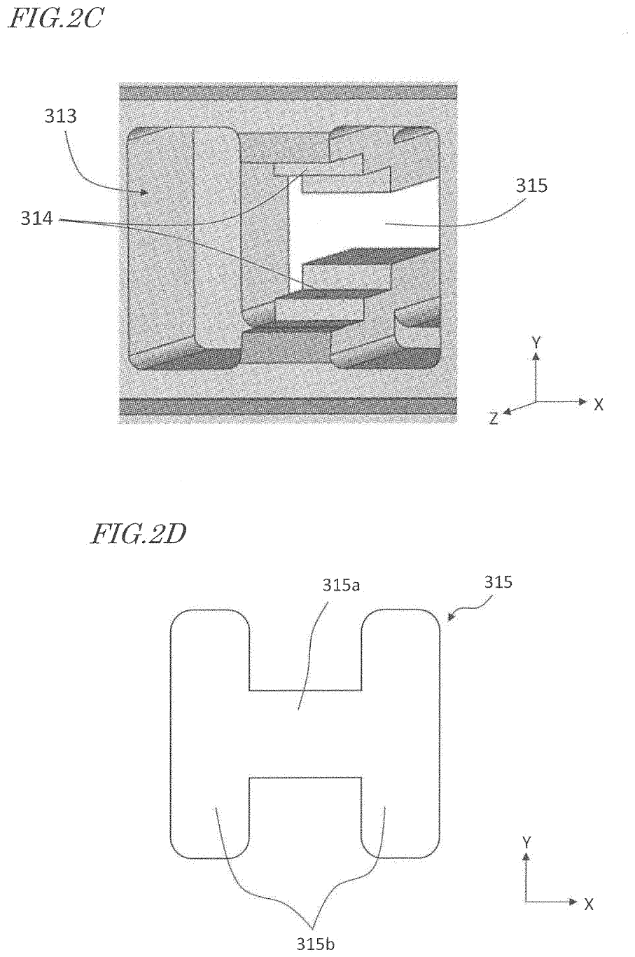

FIG. 2A is a perspective view showing the first conductive member 310. FIG. 2B is a front view showing the first conductive member 310. The first conductive member 310 has a plurality of through holes 315. Each through hole 315 opens at the base of a hollow defining a horn 313. Each through hole 315 leads into an opening at the front side of the horn 313. The shape of a cross section of each through hole 315 taken parallel to the XY plane (hereinafter “aperture shape”) resembles the alphabetical letter “H”. Such a shape is referred to as an “H shape” in the present specification.

FIG. 2C is a perspective view showing enlarged a horn 313. The pair of ridges 314 of each horn 313 in this example has a staircase structure with three steps. The pair of ridges 314 have top faces opposing each other, with an electric field oscillating mainly along the Y direction being created between these top faces. During transmission, an electromagnetic wave is propagated along the ridges 314 from the rear side toward the front side, so as to be radiated into external space.

FIG. 2D is a diagram showing an aperture shape of the through hole 315 of each horn 313. The through hole 315 in this example includes a lateral portion 315a extending along the X direction and a pair of vertical portions 315b being connected to both ends of the lateral portion 315a and extending along the Y direction. The through hole 315 may have any other shape. No matter what shape it may have, each through hole 315 has an aperture shape at least whose central portion extends along the X direction. An electromagnetic wave emerging from the core wire 342 of the coaxial cable 340 passes through the central portion of the lateral portion 315a of the through hole 315, so as to be transmitted to the ridges 314.

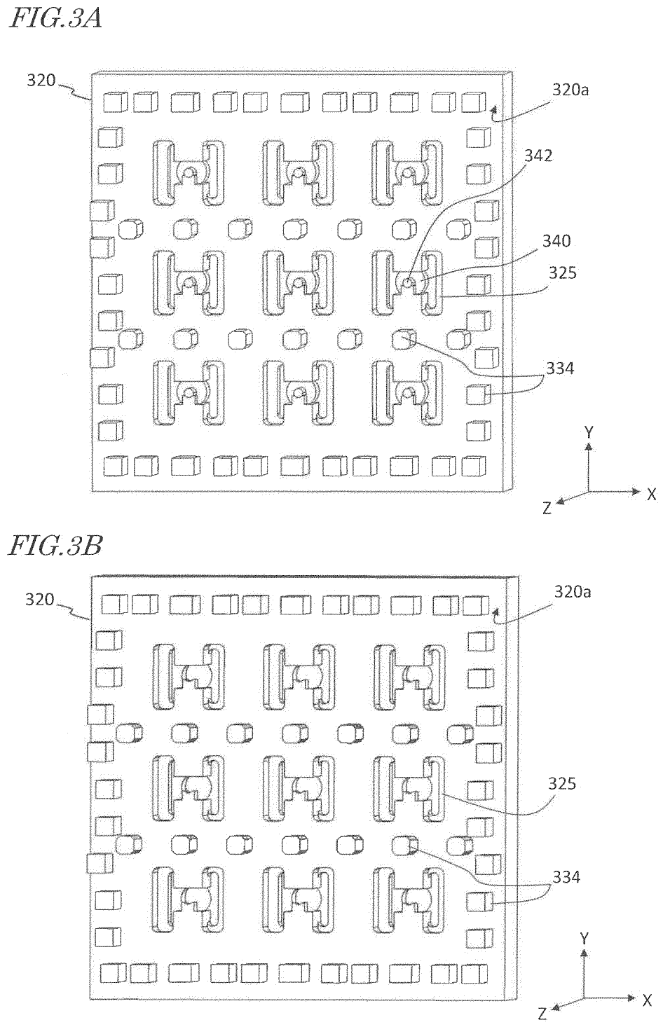

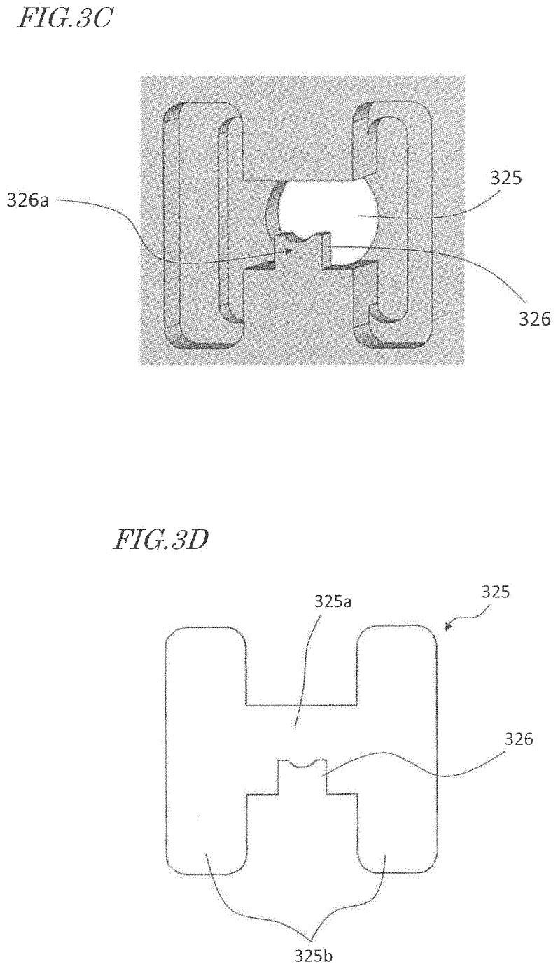

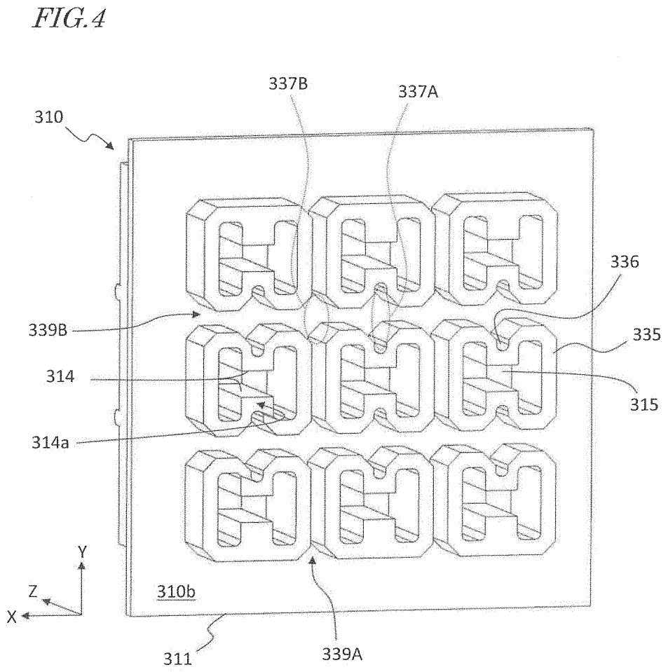

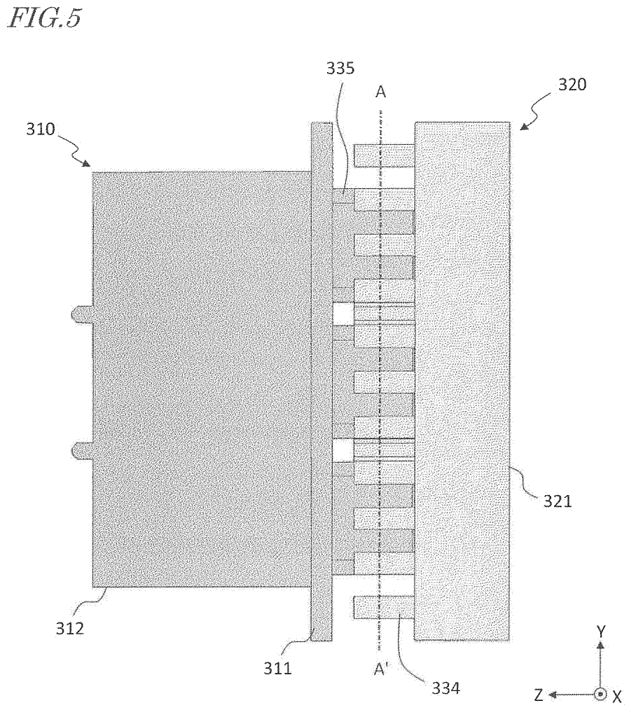

FIG. 3A is a diagram showing a structure remaining after removing the first conductive member 310 from the antenna array 300. FIG. 3B is a diagram showing a structure remaining after removing the coaxial cable 340 from the structure shown in FIG. 3A. The second conductive member 320 is a plate-shaped member having a plurality of through holes 325. The plurality of through holes 325 are disposed in positions respectively overlapping the plurality of hollows of the first conductive member 310, as viewed along a third direction (e.g., the Z direction the present example embodiment) that is perpendicular to the first and second directions. The inner surface of each through hole 325 has a junction at which the core wire 342 of a coaxial cable is connected. Each through hole 325 functions as a waveguide-to-coaxial adapter to transmit an electromagnetic wave emerging from the core wire 342 of the coaxial cable to a hollow waveguide within the horn 313.

The second conductive member 320 has the third conductive surface 320a, which is flat, on the side facing toward the first conductive member 310. The plurality of conductive rods 334 protrude from the conductive surface 320a. The plurality of conductive rods 334 are disposed in the surroundings of the through holes 325. In this example, a flat surface is shown to exist around the opening of each through hole 325; alternatively, an electrically conductive wall surrounding the opening may be provided.

The plurality of rods 334 include rods 334 which are each located away, along the Y direction, from the center portion of one of the plurality of through holes 325 as viewed along the Z direction. Some of these rods 334 are located between two adjacent through holes 325 adjoining along the Y direction. Those rods 334 which are located between through holes 325 each have an octagonal prism shape. On the other hand, those rods 334 which are located in the surroundings of the plurality of through holes 325 each have a quadrangular prism shape. Each rod 324 may have any other shape, e.g., a circular cylindrical shape. Moreover, no rods 334 may be provided in the surroundings of the plurality of through holes 325.

The plurality of rods 334 arrayed on the conductive surface 320a constitute a waffle iron structure. As will be specifically described later, the waffle iron structure suppresses leakage of electromagnetic waves. Leakage of an electromagnetic wave from each waveguide-to-coaxial adapter can be suppressed by disposing, at an appropriate interval, conductive rods 334 of appropriate shapes and dimensions in the surroundings of the through hole 325.

FIG. 3C is a diagram in which a through hole 325 is shown enlarged. The inner surface of each through hole 325 in the present example embodiment has a protrusion 326. An end face 326a (that is closer to the first conductive member 310) of the protrusion 326 is opposed to an end face (that is closer to the second conductive member 320) of one of the pair of ridges 314 (i.e., the end face 314a shown in FIG. 4). The core wire 342 of the coaxial cable 340 is to be connected to the protrusion 326. That is, the core wire 342 of the coaxial cable 340 comes in contact with the protrusion 326. Soldering or other methods may be employed to cause the core wire 342 to become mounted onto the protrusion 326.

FIG. 3D is a diagram showing the aperture shape of a through hole 325. The through hole 325 in this example includes a lateral portion 325a extending along the X direction and a pair of vertical portions 325b being connected to both ends of the lateral portion 325a and extending along the Y direction. The protrusion 326 is located in the center of the lateral portion 325a. The upper face of the protrusion 326 is curved so as to match the shape of the core wire 342. With such structure, the core wire 342 can be easily mounted to the protrusion 326.

In the present example embodiment, the protrusion 326 on the inner surface of each through hole 325 functions as a junction with the coaxial cable 340. Without being limited to such structure, the manner of connection with the coaxial cable 340 may be various. For example, the connection between the inner surface of each through hole 325 and the core wire 342 of the coaxial cable 340 may be achieved via an internal conductor (e.g., a pin) of another part such as a connector. Thus, the inner surface of each through hole 325 has a junction at which the core wire of the coaxial cable 340, or some other electrical conductor that is connected to the core wire, becomes connected.

FIG. 4 is a perspective view showing the structure on the rear side of the first conductive member 310. The first conductive member 310 has the plurality of waveguiding walls 335 on its rear side. The plurality of waveguiding walls 335 respectively surround the plurality of through holes 315. The inner surface of the each waveguiding wall 335 has an H-shaped structure, as does a cross section of the through hole 315. The inner surface of each waveguiding wall 335 has a shape defining the pair of ridges 314. The top face of each waveguiding wall 335 is opposed to the conductive surface 320a of the second conductive member 320. The top face of each waveguiding wall 335 includes the end faces 314a (that are closer to the second conductive member 320) of the pair of ridges 314. The end face 314a of one of the pair of ridges 314 is opposed to the end face 326a of the protrusion 326 of the through hole 325 shown in FIG. 3C. Each waveguiding wall 335 has a recess 336, on its outer peripheral surface facing toward another adjacent waveguiding wall 335 adjoining along the Y direction. The recesses 336 in the outer peripheral surfaces of two adjacent waveguiding walls 335 adjoining along the Y direction are opposed to each other, such that a gap enlarging portion 337 is created between these waveguiding walls 335. Moreover, between two adjacent waveguiding walls 335 adjoining along the X direction, a groove 339A extending along the Y direction exists. Similarly, between two adjacent waveguiding walls 335 adjoining along the X direction, a groove 339B extending along the X direction exists. A gap enlarging portion 337B also exists in each region where these grooves 339A and 339B intersect. In the gap enlarging portions 337A and 337B, conductive rods 334 on the second conductive member 320 are disposed. In the present example embodiment, a conductive rod 334 is disposed at a position adjoining the recesses 336 of the outer peripheral surfaces of two adjoining waveguiding walls 335. Such arrangement provides an improved isolation for radio frequency signals between a plurality of horns 313 adjoining each other along the Y direction, whereby the distance between the horns 313 can be reduced.

FIG. 5 is a side view of the antenna array 300. The plurality of conductive rods 334 on the second conductive member 320 are located between and around the plurality of waveguiding walls 335 on the first conductive member 310. With such structure, leakage of electromagnetic waves propagating between the coaxial cable 340 and the horn 313 can be effectively suppressed.

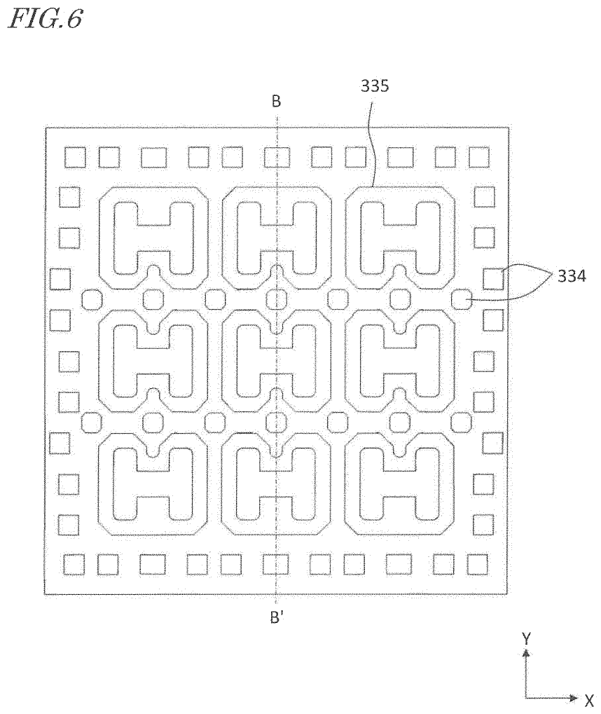

FIG. 6 is a cross-sectional view of the antenna array 300 taken along line A-A′ in FIG. 5. FIG. 6 shows both of a cross section of the waveguiding walls 335 and a cross section of the conductive rods 334. As shown in the figure, the conductive rods 334 located between the waveguiding walls 335 are accommodated in the portion of enlarged gap between the waveguiding walls 335.

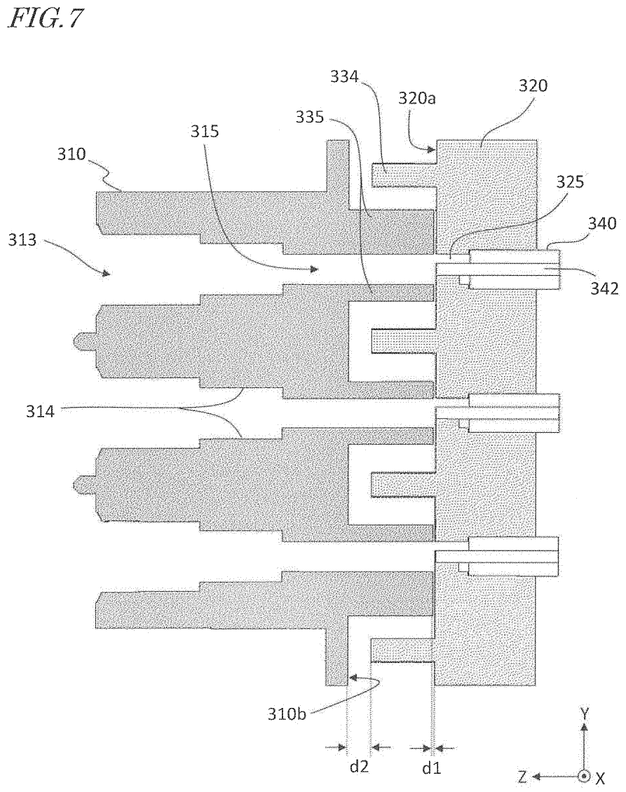

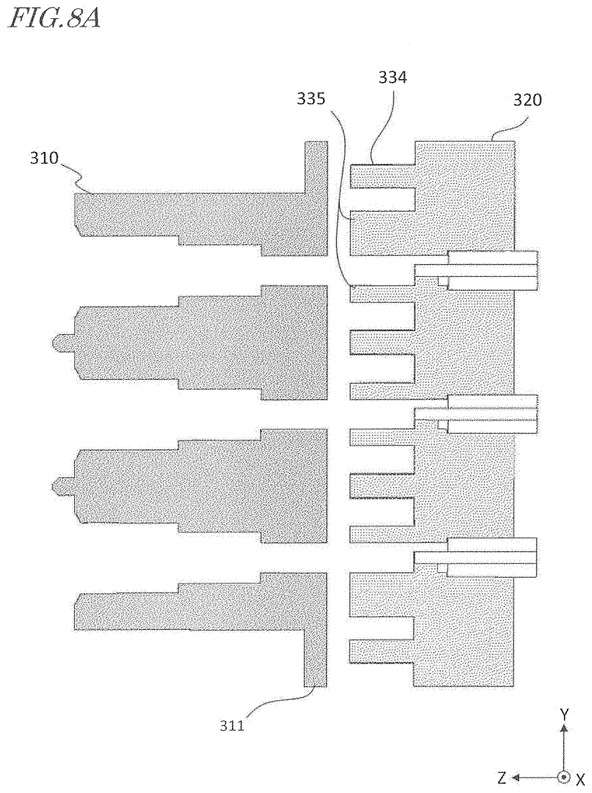

FIG. 7 is a cross-sectional view of the antenna array 300 taken along line B-B′ in FIG. 6. FIG. 7 shows a cross section of the inner wall surfaces of horns 313, a cross section of the waveguiding walls 335, and a cross section of the conductive rods 334 and the coaxial cables 340 containing their axial directions. The end of the core wire 342 of each coaxial cable 340 reaches near the conductive surface 320a of the second conductive member 320, where it is connected to the inner surface of the through hole 325. With such structure, even after the second conductive member 320 functioning as a waveguide-to-coaxial adapter array is produced, it is easier to individually check whether connection between each core wire 342 and the conductive member 320 is surely made.

In the present example embodiment, a slight gap exists between the waveguiding walls 335 and the conductive surface 320a of the second conductive member 320. The gap d1 between the waveguiding walls 335 and the conductive surface 320a is smaller than the gap d2 between the leading ends of the conductive rods 334 and the conductive surface 310b of the first conductive member 310 on the rear side. Inside each waveguiding wall 335, the through hole 315 continuing from the through hole 325 in the second conductive member 320 to the horn 313 in the first conductive member 310 is created. Note that d1 may be zero. In other words, the waveguiding walls 335 may be in contact with the conductive surface 320a of the second conductive member 320.

According to the present example embodiment, on the rear side of the first conductive member 310, the plurality of waveguiding walls 335 each surrounding one of the plurality of through holes 315 are provided. On the front side of the second conductive member 320, the plurality of conductive rods 334 are provided so as to surround the plurality of waveguiding walls 335. With such structure, signal separation between adjacent waveguide-to-coaxial adapters is improved, which allows the plurality of waveguide-to-coaxial adapters and the plurality of horns to be closely placed.

The antenna array 300 according to the present example embodiment includes: the first conductive member 310 (also referred to as a “horn array”) on which a two-dimensional array of horn antenna elements is constituted; and the second conductive member 320 (also referred to as an “adapter array”) on which a two-dimensional array of waveguide-to-coaxial adapters is constituted. The adapter array and the horn array may be fixed to each other by using parts such as screws, for example. With such structure, an antenna array which is easy to produce and easy to maintain can be realized. For example, when a problem occurs after the antenna array begins to be used, the adapter array and the horn array may be separated from each other, and then the state of connection between the core wires 342 of the coaxial cables 340 and the through hole 325 in the adapter array can be easily checked. Moreover, since the adapter array and the horn array are connected via the waffle iron structure, leakage of electromagnetic waves propagate between them can be suppressed.

A communications technique called Massive MIMO has been known in the recent years. Massive MIMO is a MIMO technique which in some cases may employ 100 or more antenna elements to realize a drastic enlargement of channel capacity. According to Massive MIMO, a multitude of users are able to simultaneously connect by using the same frequency band. Massive MIMO is useful in utilizing a relatively high frequency such as the 20 GHz band, and may be utilized in communications under the 5th-generation wireless systems (5G) or the like. An antenna array according to an example embodiment of the present disclosure can be used in communication systems utilizing Massive MIMO as such. This antenna array can be used not only in communication systems, but also in radar systems.

### Variants of First Example Embodiment

The construction described in the present example embodiment is only an example, and admits of various modifications. Hereinafter, some variants of the present example embodiment will be described.

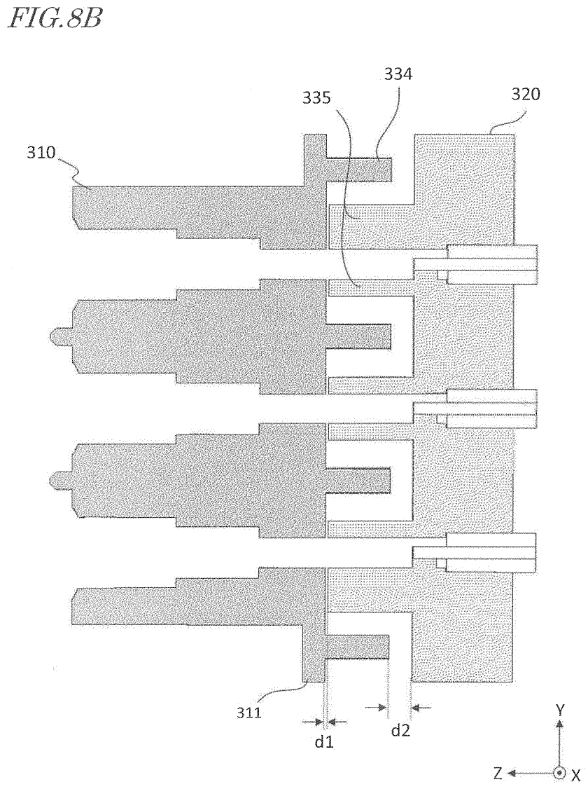

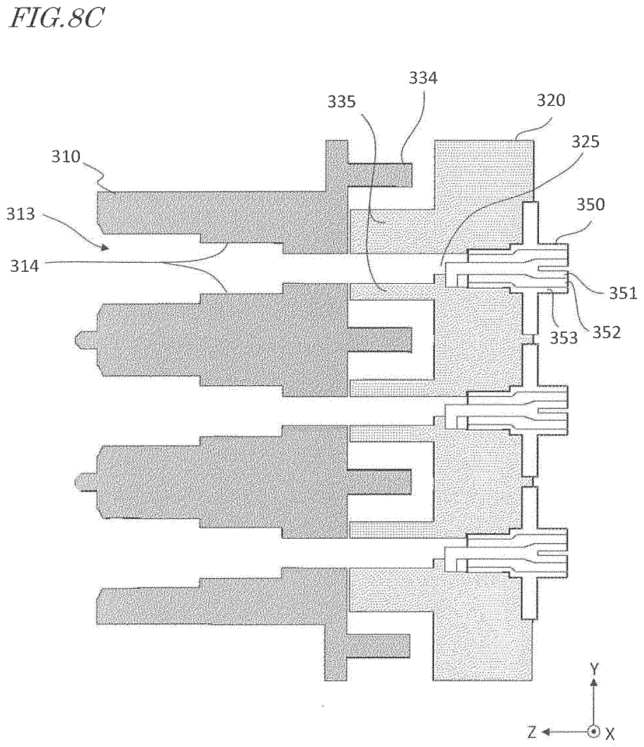

FIG. 8A is a cross-sectional view of an antenna array 300 according to a variant of the present example embodiment taken along its axial direction. In this example, the plurality of waveguiding walls 335 are connected not to the first conductive member 310 but to the second conductive member 320. In other words, the plurality of conductive rods 334, the plurality of waveguiding walls 335, and the second conductive member 320 are parts of a single-piece body. Otherwise, the structure is similar to that shown in FIG. 7. Thus, effects of the present example embodiment can be attained with a construction in which the plurality of waveguiding walls 335 are provided on the second conductive member 320.

FIG. 8B is a cross-sectional view of an antenna array 300 according to another variant of the present example embodiment taken along its axial direction. In this example, the waveguiding walls 335 are connected to the second conductive member 320, whereas the conductive rods 334 are connected to the first conductive member 310. In other words, the first conductive member 310 and the plurality of conductive rods 334 are parts of a single-piece body, whereas the second conductive member 320 and the plurality of waveguiding walls 335 are parts of another single-piece body. In the construction of FIG. 8B, too, similarly to the construction of FIG. 7, the gap d1 between the waveguiding walls 335 and the first conductive member 310 is smaller than the gap d2 between the leading ends of the conductive rods 334 and the second conductive member 320. With such construction, too, effects of the present example embodiment can be attained.

FIG. 8C is a cross-sectional view of an antenna array 300 according to still another variant of the present example embodiment taken along its axial direction. The antenna array 300 of this example further includes a plurality of connectors 350. The connectors 350 are respectively mounted to the plurality of through holes 325, at their rear side, of the second conductive member 320. Each connector 350 includes an internal conductor 351, a dielectric 352 outside the internal conductor 351, and an external conductor 353 further outside the dielectric 352. One end of the internal conductor 351 has a jack shape, while its other end is bent so as to be connected to the junction on the inner surface of the through hole 325. In this example, similar to the example of FIG. 8B, each waveguiding wall 335 is connected to the second conductive member 320, and each conductive rod 334 is connected to the first conductive member 310. Instead of the structure of FIG. 8B, a structure similar to that shown in FIG. 7 or FIG. 8A may be adopted. The inner surface of the through hole 325 according to this variant has a groove, such that the other end of the internal conductor 351 is accommodated in the groove. Instead of a jack shape, the one end of the internal conductor 351 may have a plug shape.

The structures shown in FIGS. 7 through 8C are similarly applicable to each of the example embodiments and variants described below.

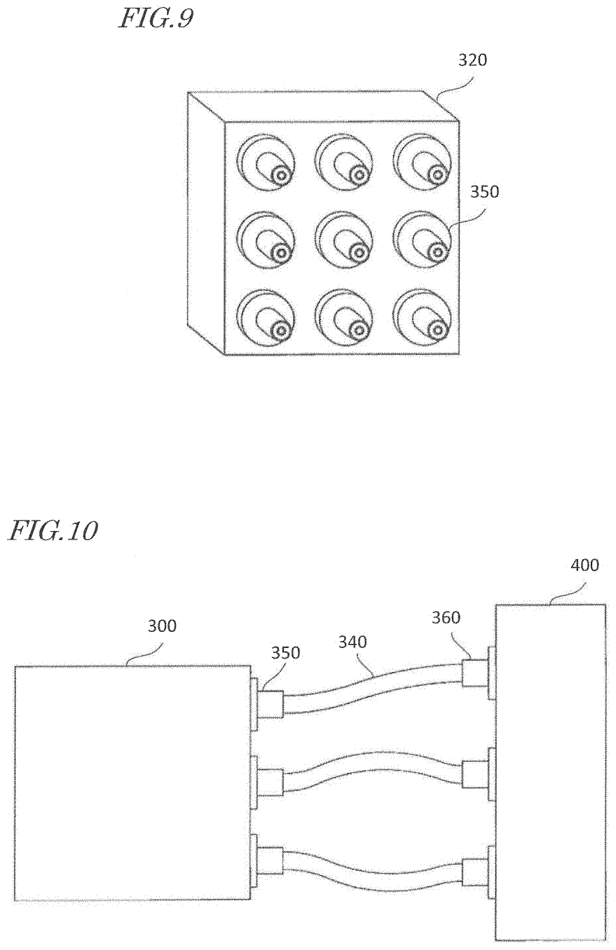

FIG. 9 is a schematic diagram showing the second conductive member 320 according to the variant of FIG. 8C as viewed from the rear side. The plurality of connectors 350 are arranged on the rear side of the second conductive member 320. The arraying interval between the connectors 350 is equal to the arraying interval of the horn antenna elements. Each connector 350 has a coaxial cable 340 connected thereto.

FIG. 10 is a diagram schematically showing an exemplary construction of a communication system that includes the antenna array 300 and a communications device 400. This system may be a Massive MIMO system, for example. The communications device 400 includes a plurality of connectors 360. The antenna array 300 and the communications device 400 are connected via the plurality of coaxial cables 340. The communications device 400 accommodates a plurality of transmitters inside, and is able to transmit signals of independent phases to the respective coaxial cables 340. The number of coaxial cables 340 is equal to the number of horn antenna elements in the antenna array 300. The interval between connectors 350 in the antenna array 300 is smaller than the interval between connectors 360 in the communications device 400.

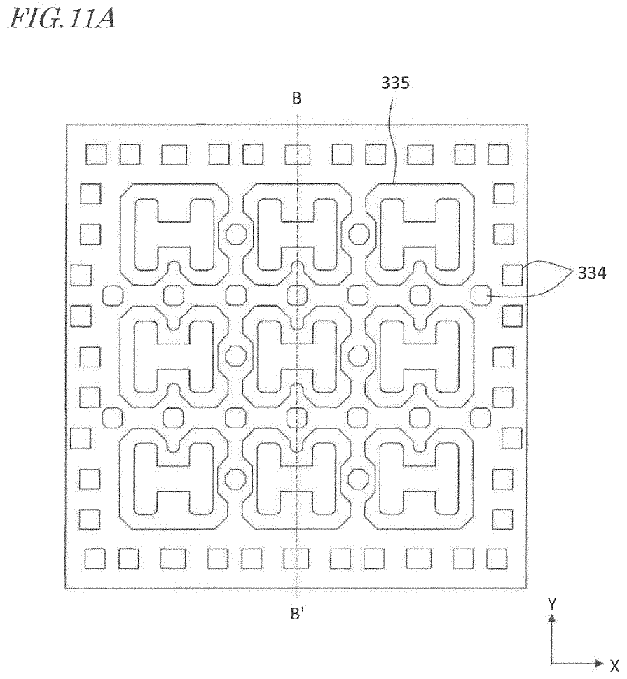

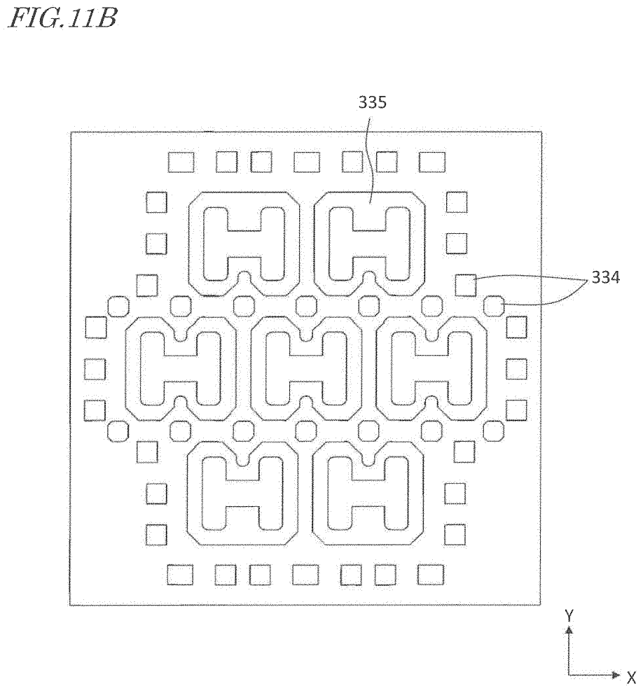

FIG. 11A is a diagram showing a variant of the cross-sectional structure shown in FIG. 6. In this example, among the plurality of waveguiding walls 335, conductive rods 334 are also disposed between two adjacent waveguiding walls 335 adjoining along the X direction. The outer peripheral surface of each waveguiding wall 335 has a recess in a site opposing another waveguiding wall 335 along the X direction. A conductive rod 334 is disposed in each gap enlarging portion between the recesses of two adjacent waveguiding walls 335 adjoining along the X direction. With such structure, signal separation between two adjacent horns 313 adjoining along the X direction is improved.

FIG. 11B is a diagram showing another variant of the cross-sectional structure shown in FIG. 6. In this example, the plurality of waveguiding walls 335, and the plurality of horns 313 are arrayed in a hexagonal lattice. With such construction, signal separation between adjacent horns 313 along the Y direction is expected to be improved.

### Second Example Embodiment

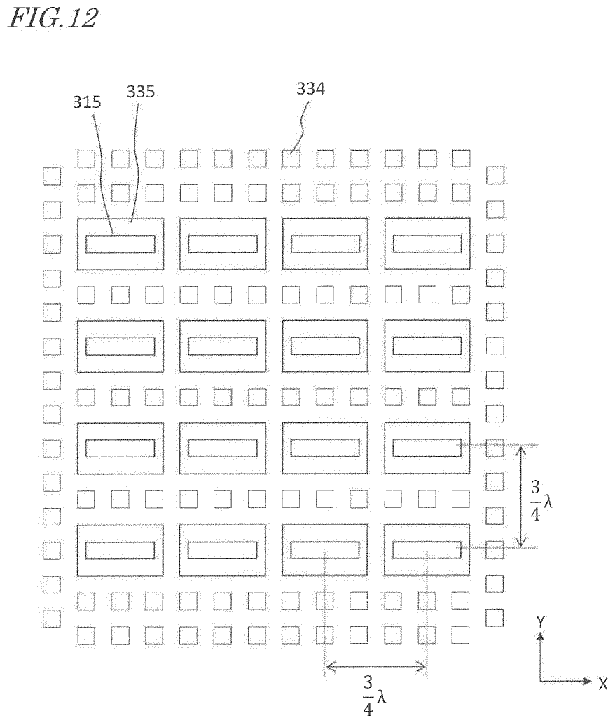

FIG. 12 is a diagram showing the structure of a cross section of an antenna array according to the second example embodiment as taken in parallel to the XY plane. The illustrated cross section corresponds to the A-A′ cross section in FIG. 5. In the present example embodiment, the through holes 315 in the first conductive member 310 and the through holes 325 in the second conductive member 320 each have an aperture shape extending along the X direction. Such a shape will be referred to as an “I shape” in the present specification. The waveguiding wall 335 surrounding each through hole 315 also has a cross section in the shape of a simple rectangle. Between two adjacent waveguiding walls 335 adjoining along the shorter-side direction of the through holes 315, a plurality of conductive rods 334 are disposed. In this example, the arraying interval between through holes 315 is (¾)λ along either the shorter-side direction (the Y direction) or the longer-side direction (the X direction) of the through holes 315. Note that A denotes the free space wavelength of an electromagnetic wave to be transmitted or received by this antenna array.

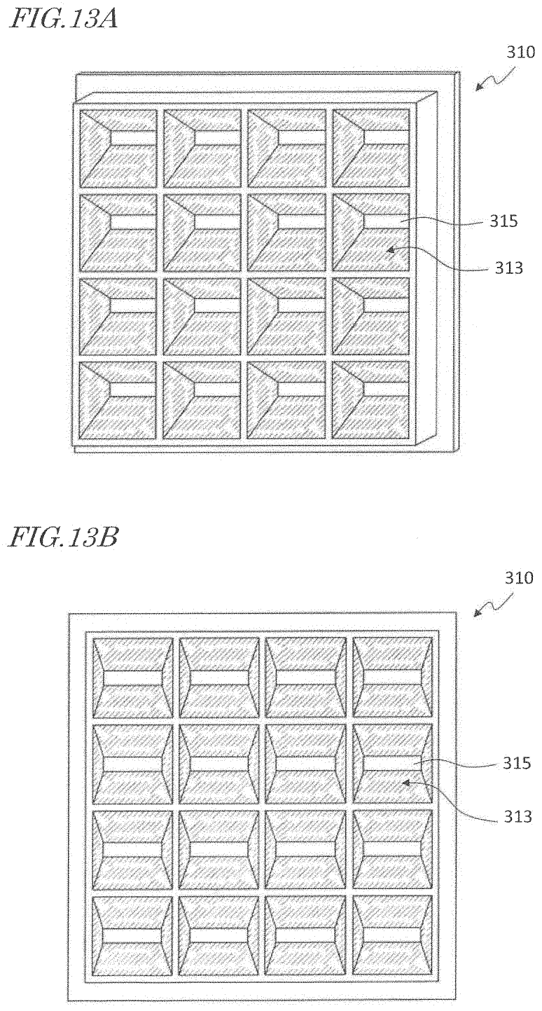

FIG. 13A is a perspective view showing a horn array according to the second example embodiment. FIG. 13B is a plan view showing the horn array according to the second example embodiment. In these figures, each site shown hatched represents the inner surface of a horn 313. The inner surface of each horn 313 according to the present example embodiment presents smooth slopes becoming gradually wider apart from the rear side toward the front side. Unlike in the first example embodiment, no ridges 314 are provided on the inner surface of each horn 313.

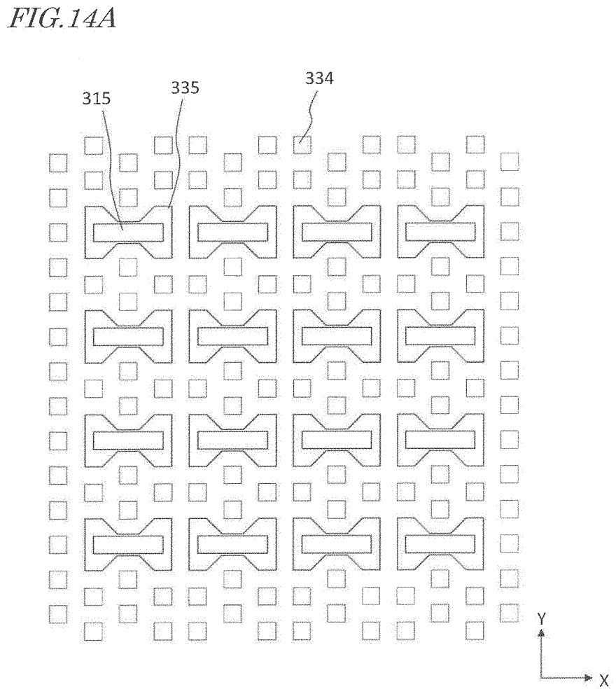

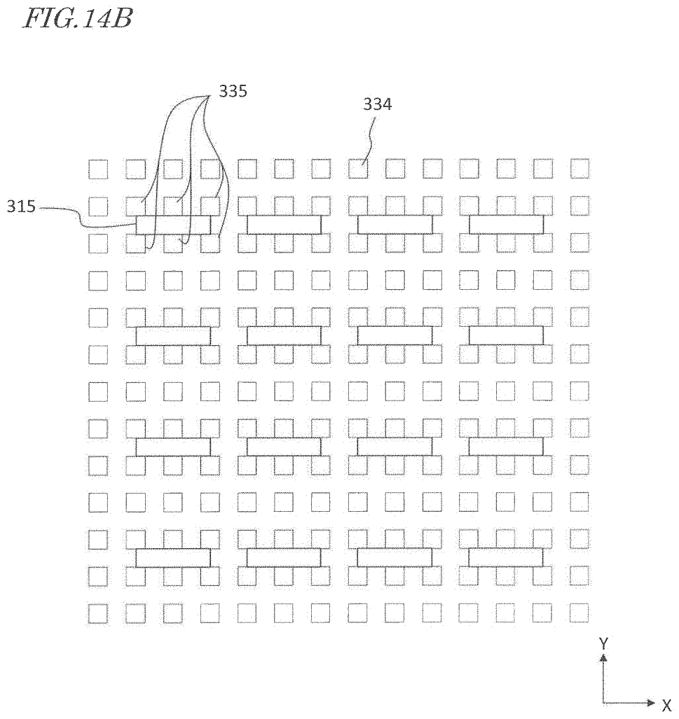

FIG. 14A is a diagram showing the structure of a cross section of an antenna array according to a variant of the second example embodiment as taken in parallel to the XY plane. In the example of FIG. 14A, each longer side of each waveguiding wall 335 is thinner near its center, such that a portion of enlarged gap is created with another adjacent waveguiding wall 335 adjoining along the shorter-side direction. In this portion of enlarged gap, two conductive rods 334 are accommodated. With such construction, separation of signal waves propagating between two adjacent through holes 315 adjoining along the shorter-side direction is further enhanced.

FIG. 14B is a diagram showing the structure of a cross section of an antenna array according to another variant of the second example embodiment as taken in parallel to the XY plane. In this example, each waveguiding wall 335 is composed of a plurality of split portions, rather than being one continuous wall. Each portion of the waveguiding wall 335 has an identical or similar rod shape to that of a conductive rod 334. Although each waveguiding wall 335 is split into a plurality of portions, portions of the waveguiding wall 335 are disposed at sites adjoining the central portion of each through hole 315. As a result, leakage of signal waves can be suppressed.

### Third Example Embodiment

FIG. 15 is a diagram showing the structure of a cross section of an antenna array according to a third example embodiment as taken in parallel to the XY plane. In the present example embodiment, the arraying interval of the through holes 315 along the shorter-side direction (the Y direction) is λ/2, whereas the arraying interval of the through holes 315 along the longer-side direction (the X direction) is (¾)λ. The waveguiding walls 335 is thinner at sites adjoining the central portion of each through hole 315. Although each through hole 315 has an I shape, its width along the Y direction is larger at both ends. By adopting such a shape for the through holes 315, it becomes easier to adjust the degree of matching of electromagnetic waves.

### Fourth Example Embodiment

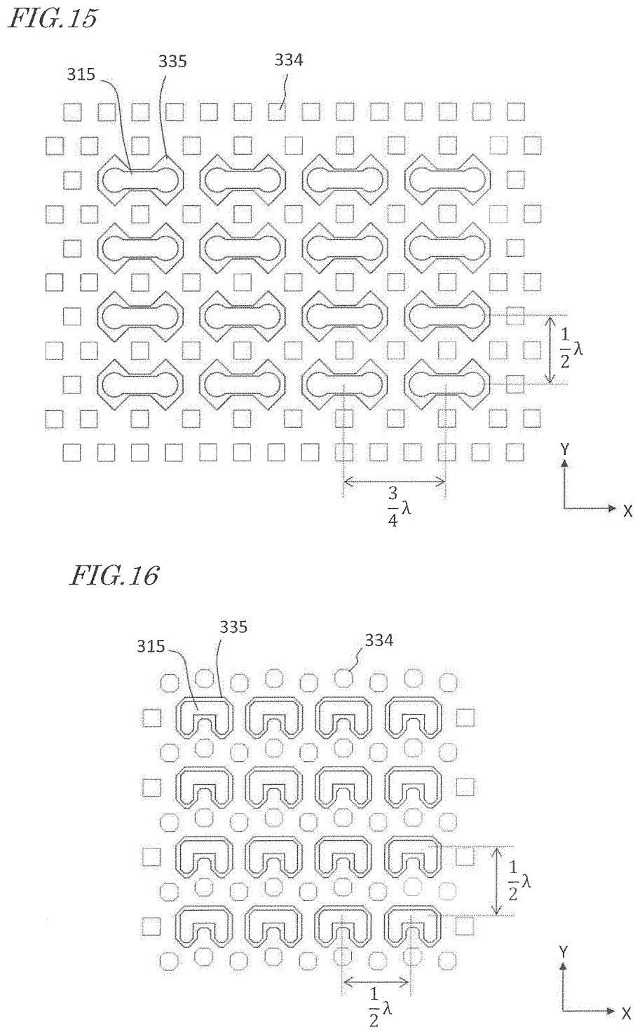

FIG. 16 is a diagram showing the structure of a cross section of an antenna array according to a fourth example embodiment as taken in parallel to the XY plane. In the present example embodiment, the arraying interval of the through holes 315 is λ/2 along either the X direction or the Y direction. In order to realize this arraying interval, through holes 315 with a U shape are adopted. In the lateral portion (extending along the X direction) of each U-shaped through hole 315, the outer peripheral surface of the waveguiding wall 335 has a recess. As a result, a gap enlarging portion is created between two adjacent waveguiding walls 335 adjoining along the Y direction. A conductive rod 334 is disposed adjacent each gap enlarging portion.

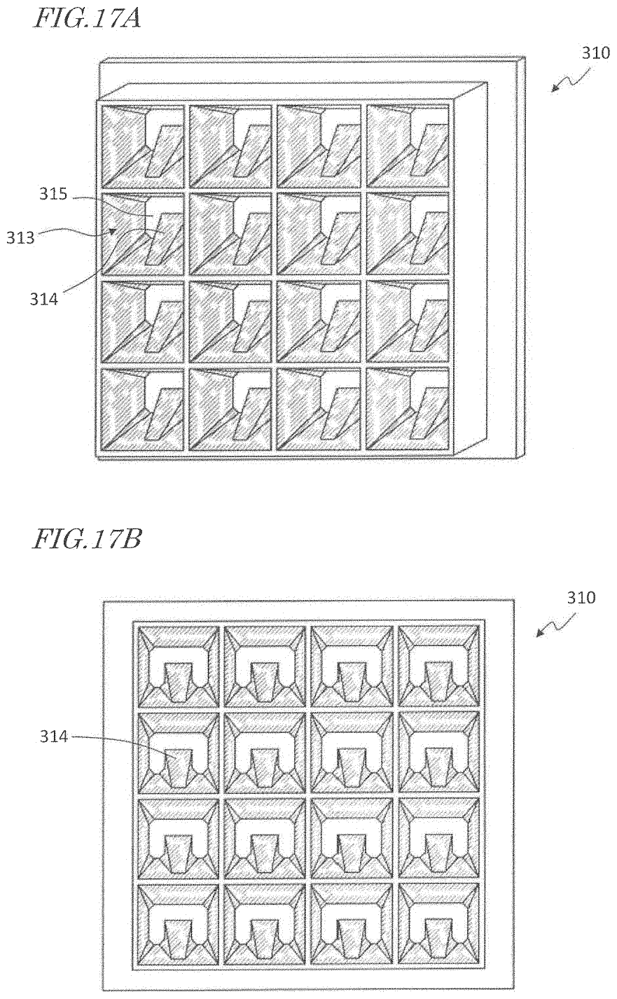

FIG. 17A is a perspective view showing a horn array according to a fourth example embodiment. FIG. 17B is a front view showing the horn array according to the fourth example embodiment. In these figures, each site shown hatched represents the inner surface of a horn.

In the present example embodiment, each horn 313 in the horn array is a ridge horn having one ridge 314 in its inner surface. The ridge 314 protrudes from the inner surface in a direction intersecting the first direction and guides an electromagnetic wave emerging from the coaxial cable into external space. The width of the ridge 314 becomes narrower toward the opening in the front side of the horn. Without being limited to such structure, the width of the ridge 314 may be constant. Although the ridge 314 does not reach the opening in the front side of each horn 313 in this example, the far end of the ridge 314 may alternatively be flush with the opening in the front side of the horn 313.

### <Variants of Through Hole>

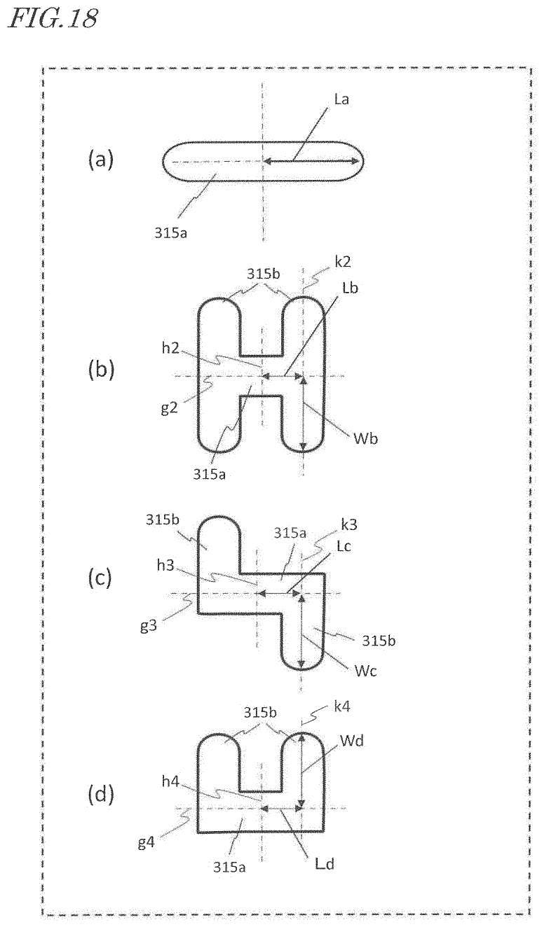

The shapes of the through holes 315 and 325 are not limited to the shapes which have been described above. So long as radiation or reception of electromagnetic waves is possible, the shapes of the through holes 315 and 325 may have any arbitrary designed. Hereinafter, with reference to FIG. 18, some exemplary shapes of the through holes 315 and 325 and dimensional conditions will be described. Although FIG. 18 illustrates through holes 315, the following description similarly applies also to the shape of the through holes 325.

In FIG. 18, (a) shows an exemplary through hole 315 having the shape of an ellipse. The semimajor axis La of the through hole 315, indicated by arrowheads in the figure, is chosen so that higher-order resonance will not occur and that the impedance will not be too small. More specifically, La may be set so that λo/4<La<λo/2, where λo is a wavelength in free space corresponding to the center frequency in the operating frequency band.

In FIG. 18, (b) shows an exemplary through hole 315 having an H shape which includes a pair of vertical portions 315b and a lateral portion 315a interconnecting the pair of vertical portions 315b. The lateral portion 315a is substantially perpendicular to the pair of vertical portions 315b, and connects between substantial central portions of the pair of vertical portions 315b. The shape and size of such an H-shaped through hole 315 are also to be determined so that higher-order resonance will not occur and that the impedance will not be too small. The distance between a point of intersection between the center line g2 of the lateral portion 315a and the center line h2 of the entire H shape perpendicular to the lateral portion 315a and a point of intersection between the center line g2 and the center line k2 of a vertical portion 315b is denoted as Lb. The distance between a point of intersection between the center line g2 and the center line k2 and the end of the vertical portion 315b is denoted as Wb. The sum of Lb and Wb is chosen so as to satisfy λo/4<Lb+Wb<λo/2. Choosing the distance Wb to be relatively long allows the distance Lb to be relatively short. As a result, the width of the H shape along the X direction can be e.g. less than λo/2, whereby the interval between the lateral portions 315a along the length direction can be made short.

In FIG. 18, (c) shows an exemplary through hole 315 which includes a lateral portion 315a and a pair of vertical portions 315b extending from both ends of the lateral portion 315a. The directions in which the pair of vertical portions 315b extend from the lateral portion 315a are substantially perpendicular to the lateral portion 315a, and are opposite to each other. The distance between a point of intersection between the center line g3 of the lateral portion 315a and the center line h3 of the overall shape which is perpendicular to the lateral portion 315a and a point of intersection between the center line g3 and the center line k3 of a vertical portion 315b is denoted as Lc. The distance between a point of intersection between the center line g3 and the center line k3 and the end of the vertical portion 315b is denoted as Wc. The sum of Lc and Wc is chosen so as to satisfy λo/4<Lc+Wc<λo/2. Choosing the distance Wc to be relatively long allows the distance Lc to be relatively short. As a result, the width along the X direction of the overall shape in (c) of FIG. 18 can be e.g. less than λo/2, whereby the interval between the lateral portions 315a along the length direction can be made short.

In FIG. 18, (d) shows an exemplary through hole 315 which includes a lateral portion 315a and a pair of vertical portions 315b extending from both ends of the lateral portion 315a in an identical direction which is perpendicular to the lateral portion 315a. Such a shape may be referred to as a “U shape” in the present specification. Note that the shape shown in (d) of FIG. 18 may be regarded as an upper half shape of an H shape. The distance between a point of intersection between the center line g4 of the lateral portion 315a and the center line h4 of the overall U shape which is perpendicular to the lateral portion 315a and a point of intersection between the center line g4 and the center line k4 of a vertical portion 315b is denoted as Ld. The distance between a point of intersection between the center line g4 and the center line k4 and the end of the vertical portion 315b is denoted as Wd. The sum of Ld and Wd is chosen so as to satisfy λo/4<Ld+Wd<λo/2. Choosing the distance Wd to be relatively long allows the distance Ld to be relatively short. As a result, the width along the X direction of the U shape can be e.g. less than λo/2, whereby the interval between the lateral portions 315a along the length direction can be made short.

The direction that the vertical portions 315b of each through hole 315 extend as shown in (b) through (d) of FIG. 18 is not limited to a direction that is perpendicular to the direction that the lateral portion 315a extends. The direction that the vertical portions 315b extend may be a direction that intersects, at an angle which is not 90 degrees, the direction that the lateral portion 315a extends.

### <Details of Waffle Iron Structure>

Next, the waffle iron structure of the antenna array in each of the above example embodiments will be described in more detail.

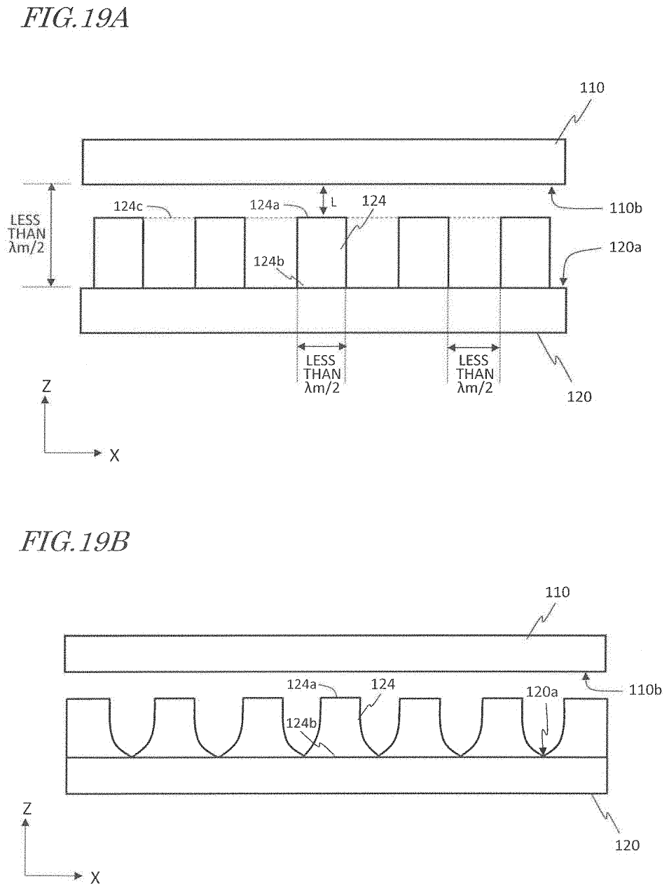

FIG. 19A is a diagram showing an exemplary range of dimension of each member in the waffle iron structure. Herein, by taking the structure of FIG. 19A as an example, conditions such as dimensions will be described. The following description is similarly applicable to the waffle iron structure at any place in an example embodiment of the present disclosure.

FIG. 19A shows a partial construction of a device that includes conductive members 110 and 120 opposing each other and a plurality of conductive rods 124 which are connected to the conductive member 120. The conductive member 110 corresponds to one of the first conductive member 310 and the second conductive member 320 in each of the above-described example embodiments. The conductive member 120 corresponds to the other of the first conductive member 310 and the second conductive member 320 in each of the above-described example embodiments. The conductive rods 124 correspond to the conductive rods 334 in each of the above-described example embodiments.

In the example of FIG. 19A, the conductive surface 110b of the conductive member 110 has a two-dimensional expanse along a plane which is orthogonal to the axial direction (the Z direction) of each conductive rod 124 (i.e., along a plane which is parallel to the XY plane). Although the conductive surface 110b of this example is a smooth plane, the conductive surface 110b does not need to be a smooth plane.

The plurality of conductive rods 124 arrayed on the conductive member 120 each have a leading end 124a opposing the conductive surface 110b. In the example shown in the figure, the leading ends 124a of the plurality of conductive rods 124 are on the same plane. This plane defines the surface 124c of an artificial magnetic conductor. Each conductive rod 124 does not need to be entirely electrically conductive, so long as it at least includes an electrically conductive layer that extends along the upper face and the side face of the rod-like structure. Although this electrically conductive layer may be located at the surface layer of the rod-like structure, the surface layer may be composed of an insulation coating or a resin layer with no electrically conductive layer existing on the surface of the rod-like structure. Moreover, each conductive member 120 does not need to be entirely electrically conductive, so long as it can support the plurality of conductive rods 124 to constitute an artificial magnetic conductor. Of the surfaces of the conductive member 120, a face carrying the plurality of conductive rods 124 may be electrically conductive, such that the electrical conductor electrically interconnects the surfaces of adjacent ones of the plurality of conductive rods 124. Moreover, the electrically conductive layer of the conductive member 120 may be covered with an insulation coating or a resin layer. In other words, the entire combination of the conductive member 120 and the plurality of conductive rods 124 may at least include an electrically conductive layer with rises and falls opposing the conductive surface 110b of the conductive member 110.

The space between the surface 124c of each stretch of artificial magnetic conductor and the conductive surface 110b of the conductive member 110 does not allow an electromagnetic wave of any frequency that is within a specific frequency band to propagate. This frequency band is called a “prohibited band”. The artificial magnetic conductor is designed so that the frequency of an electromagnetic wave to propagate in the waveguide (which may hereinafter be referred to as the “operating frequency”) is contained in the prohibited band. The prohibited band may be adjusted based on the following: the height of the conductive rods 124, i.e., the depth of each groove formed between adjacent conductive rods 124; the width of each conductive rod 124; the interval between conductive rods 124; and the size of the gap between the leading end 124a and the conductive surface 110b of each conductive rod 124.

The antenna array is used for at least one of transmission and reception of electromagnetic waves of a predetermined band (referred to as the “operating frequency band”). λo denotes a free-space wavelength of an electromagnetic wave having the center frequency of the operating frequency band of the antenna array, whereas λm denotes a free-space wavelength of an electromagnetic wave of the highest frequency in the operating frequency band. The end of each conductive rod 124 that is in contact with the conductive member 120 is referred to as the “root”. Each conductive rod 124 has the leading end 124a and the root 124b. Examples of dimensions, shapes, positioning, and the like of the respective members are as follows.

### (1) Width of the Conductive Rod

The width (i.e., the size along the X direction and the Y direction) of the conductive rod 124 may be set to less than λm/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

(2) Distance from the Root of the Conductive Rod to the Conductive Surface of the Conductive Member 110

The distance from the root 124b of each conductive rod 124 to the conductive surface 110b of the conductive member 110 may be longer than the height of the conductive rods 124, while also being less than λm/2. When the distance is λm/2 or more, resonance may occur between the root 124b of each conductive rod 124 and the conductive surface 110b, thus reducing the effect of signal wave containment.

The distance from the root 124b of each conductive rod 124 to the conductive surface 110b of the conductive member 110 corresponds to the spacing between the conductive member 110 and the conductive member 120. For example, when a signal wave of 76.5±0.5 GHz (which belongs to the millimeter band or the extremely high frequency band) propagates in the transmission line, the wavelength of the signal wave is in the range from 3.8923 mm to 3.9435 mm. Therefore, λm equals 3.8923 mm in this case, so that the spacing between the conductive member 110 and the conductive member 120 may be set to less than a half of 3.8923 mm. So long as the conductive member 110 and the conductive member 120 realize such a narrow spacing while being disposed opposite from each other, the conductive member 110 and the conductive member 120 do not need to be strictly parallel. Moreover, when the spacing between the conductive member 110 and the conductive member 120 is less than λm/2, a whole or a part of the conductive member 110 and/or the conductive member 120 may be shaped as a curved surface. On the other hand, the conductive members 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

Although the conductive surface 120a is illustrated as planar in the example shown in FIG. 19A, example embodiments of the present disclosure are not limited thereto. For example, as shown in FIG. 19B the conductive surface 120a may be the bottom parts of faces each of which has a cross section (taken parallel to the XZ plane) similar to a U-shape or a V-shape. The conductive surface 120a will have such a structure when each conductive rod 124 is shaped with a width which increases from the leading end 124a toward the root 124b. Even with such a structure, the illustrated device can function as an antenna array according to an example embodiment of the present disclosure so long as the distance between the conductive surface 110b and the conductive surface 120a is less than a half of the wavelength λm.

(3) Distance L from the Leading End of the Conductive Rod to the Conductive Surface of the Conductive Member 110

The distance L from the leading end 124a of each conductive rod 124 to the conductive surface 110b is set to less than λm/2. When the distance is λm/2 or more, a propagation mode where electromagnetic waves reciprocate between the leading end 124a of each conductive rod 124 and the conductive surface 110b may occur, thus no longer being able to contain an electromagnetic wave. Note that the plurality of conductive rods 124 do not have their leading ends in electrical contact with the conductive surface 110b. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface. For manufacturing ease, the distance L may be set to e.g. λm/16 or more when an electromagnetic wave in the millimeter band is to be propagated.

The lower limit of the distance L between the conductive surface 110b and the leading end 124a of each conductive rod 124 depends on the machining precision, and also on the precision when assembling the two upper/lower conductive members 110 and 120 so as to be apart by a constant distance. When a pressing technique or an injection technique is used, the practical lower limit of the aforementioned distance is about 50 micrometers (μm). In the case of using an MEMS (Micro-Electro-Mechanical System) technique to make a product in e.g. the terahertz range, the lower limit of the aforementioned distance is about 2 to about 3 μm.

### (4) Arrangement and Shape of Conductive Rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110b. Therefore, the width of the interspace between rods may be appropriately determined depending on other design parameters. Although there is no clear lower limit to the width of the interspace between rods, for manufacturing ease, it may be e.g. λm/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straight-forward regularity. The conductive rods 124 may also vary in shape and size depending on the position on the conductive member 120.

The surface 124c of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to an antenna array according to the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124, i.e., the length from the root 124b to the leading end 124a, may be set to a value which is shorter than the distance (i.e., less than λm/2) between the conductive surface 110b and the conductive surface 120a, e.g., λo/4.

An antenna array according to an example embodiment of the present disclosure can be used in a wireless communication system, for example. Such a wireless communication system would include an antenna array according to any of the above-described example embodiments and a communications device (i.e., a transmission circuit or a reception circuit). The transmission circuit may be constructed so as to allow a signal wave representing a signal for transmission to be supplied to a waveguide within the array antenna, for example. The reception circuit may be constructed so as to demodulate a signal wave which has been received via the array antenna and output it as an analog or digital signal.

An antenna array or an antenna device according to an example embodiment of the present disclosure can also be used in a radar device or a radar system to be incorporated in moving entities such as vehicles, marine vessels, aircraft, robots, or the like, for example. A radar device would include an antenna array according to an example embodiment of the present disclosure and a microwave integrated circuit, e.g., MMIC, that is connected to the antenna array. A radar system would include the radar device and a signal processing circuit that is connected to the microwave integrated circuit of the radar device.

The signal processing circuit may be configured to estimate an azimuth of each arriving wave by executing an algorithm such as the MUSIC method, the ESPRIT method, or the SAGE method, and output a signal indicating the estimation result. The signal processing circuit may further be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoCs). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory devices (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

An antenna array according to an example embodiment of the present disclosure can further be used as an antenna in an indoor positioning system (IPS). An indoor positioning system is able to identify the position of a moving entity, such as a person or an automated guided vehicle (AGV), that is in a building. An antenna array can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of a radar system, a communication system, and various monitoring systems including an antenna array having a waffle iron structure are disclosed in the specification of U.S. Pat. Nos. 9,786,995 and 10,027,032, for example. The entire disclosure of these publications is incorporated herein by reference. An antenna array according to the present disclosure is applicable to each application example that is disclosed in these publications.

An antenna array according to the present disclosure is usable in any technological field that utilizes electromagnetic waves. For example, it is available to various applications where transmission/reception of electromagnetic waves of the gigahertz band or the terahertz band is performed. The antenna array may be used in a wireless communication system such as a Massive MIMO system, for example. The antenna array may also be used in onboard radar systems, various types of monitoring systems, and indoor positioning systems.

This application is based on Japanese Patent Applications No. 2018-153879 filed on Aug. 20, 2018, the entire contents of which are hereby incorporated by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An antenna array comprising:
a first electrically conductor including a first electrically conductive surface at a front side, a second electrically conductive surface at a rear side, and a plurality of hollows respectively defining a plurality of horns each defining and functioning as an antenna element, each of the plurality of hollows opening in the first electrically conductive surface and in the second electrically conductive surface, and the plurality of horns including three or more horns that are arrayed along a first direction and along a second direction, the first direction and the second direction intersecting each other;
a second electrically conductor including a third electrically conductive surface opposing the second electrically conductive surface and a plurality of through holes, the plurality of through holes respectively overlapping the plurality of hollows when seen through in a third direction which is orthogonal to both of the first direction and the second direction, and an inner surface of each of the plurality of through holes including a junction at which a core wire of a coaxial cable or another electrical conductor that is connected to the core wire is connected;
a plurality of waveguiding walls located between the second electrically conductive surface and the third electrically conductive surface, each waveguiding wall surrounding at least a portion of a space between one of the plurality of hollows and one of the plurality of through holes; and
a plurality of electrically conductive rods each including a root that is connected to one of the second electrically conductive surface and the third electrically conductive surface and a leading end that is opposed to another of the second electrically conductive surface and the third electrically conductive surface, the plurality of electrically conductive rods being located in surroundings of the plurality of waveguiding walls.

2. The antenna array of claim 1, wherein
an inner surface of each of the plurality of hollows includes at least one ridge that guides an electromagnetic wave emerging from the coaxial cable into external space; and
the at least one ridge protrudes from the inner surface of the hollow in a direction orthogonal or substantially orthogonal to the first direction.

3. The antenna array of claim 2, wherein
the at least one ridge includes a pair of ridges including top surfaces opposing each other; and
an interval between the pair of ridges enlarges from the rear side toward the front side.

4. The antenna array of claim 1, wherein
an inner surface of each of the plurality of hollows includes at least one ridge that guides an electromagnetic wave emerging from the coaxial cable into an external space;
the at least one ridge protrudes from the inner surface of the hollow in a direction orthogonal or substantially orthogonal to the first direction;
the inner surface of each of the plurality of through holes includes a protrusion;
the junction is located on the protrusion;
the core wire or the other electrical conductor is in contact with the protrusion; and
an end surface, that is closer to the first electrically conductor, of the protrusion is opposed to an end surface, that is closer to the second electrically conductor, of one of the at least one ridge.

5. The antenna array of claim 3, wherein,
the inner surface of each of the plurality of through holes includes a protrusion;
the junction is located on the protrusion;
the core wire or the other electrical conductor is in contact with the protrusion; and
an end surface, that is closer to the first electrically conductor, of the protrusion is opposed to an end surface, that is closer to the second electrically conductor, of one of the at least one ridge.

6. The antenna array of claim 2, wherein the plurality of electrically conductive rods include an electrically conductive rod that is spaced away, along a direction which is orthogonal or substantially orthogonal to the first direction, from a center portion of one of the plurality of through holes as viewed along the third direction.

7. The antenna array of claim 2, wherein
the at least one ridge includes a pair of ridges including top surfaces opposing each other;
an interval between the pair of ridges enlarges from the rear side toward the front side;
the inner surface of each of the plurality of through holes includes a protrusion;
the junction is located on the protrusion;
the core wire or the other electrical conductor is in contact with the protrusion; and
an end surface, that is closer to the first electrically conductor, of the protrusion is opposed to an end surface, that is closer to the second electrically conductor, of one of the at least one ridge; and
the plurality of electrically conductive rods include an electrically conductive rod that is spaced away, along a direction which is orthogonal or substantially orthogonal to the first direction, from a center portion of one of the plurality of through holes as viewed along the third direction.

8. The antenna array of claim 1, wherein
at least one of the plurality of waveguiding walls include a recess on an outer peripheral surface facing toward another adjacent waveguiding wall adjoining along the second direction; and
one of the plurality of electrically conductive rods adjoins the recess.

9. The antenna array of claim 3, wherein
the inner surface of each of the plurality of through holes includes a protrusion;
the junction is located on the protrusion;
the core wire or the other electrical conductor is in contact with the protrusion;
an end surface, that is closer to the first electrically conductor, of the protrusion is opposed to an end surface, that is closer to the second electrically conductor, of one of the at least one ridge;
at least one of the plurality of waveguiding walls include a recess on an outer peripheral surface facing toward another adjacent waveguiding wall adjoining along the second direction; and
one of the plurality of electrically conductive rods adjoins the recess, the one of the electrically conductive rods being spaced away, along a direction which is orthogonal or substantially orthogonal to the first direction, from a center portion of one of the plurality of through holes as viewed along the third direction.

10. The antenna array of claim 1, wherein, among the plurality of waveguiding walls, a groove is located between two adjacent waveguiding walls adjoining along the first direction, the groove extending along a direction which is orthogonal or substantially orthogonal to the first direction.

11. The antenna array of claim 1, wherein
an inner surface of each of the plurality of hollows includes at least one ridge that guides an electromagnetic wave emerging from the coaxial cable into external space;
the at least one ridge protrudes from the inner surface of the hollow in a direction orthogonal or substantially orthogonal to the first direction; and
among the plurality of waveguiding walls, a groove exists between two adjacent waveguiding walls adjoining along the first direction, the groove extending along a direction which is orthogonal or substantially orthogonal to the first direction.

12. The antenna array of claim 2, wherein
the at least one ridge includes a pair of ridges including top surfaces opposing each other;
an interval between the pair of ridges enlarges from the rear side toward the front side;
the inner surface of each of the plurality of through holes includes a protrusion;
the junction is located on the protrusion;
the core wire or the other electrical conductor is in contact with the protrusion;
an end surface, that is closer to the first electrically conductor, of the protrusion is opposed to an end surface, that is closer to the second electrically conductor, of one of the at least one ridge;
at least one of the plurality of waveguiding walls includes a recess on an outer peripheral surface facing toward another adjacent waveguiding wall adjoining along the second direction;
one of the plurality of electrically conductive rods adjoins the recess, the one of the electrically conductive rods being spaced away, along a direction which is orthogonal or substantially orthogonal to the first direction, from a center portion of one of the plurality of through holes as viewed along the third direction; and
among the plurality of waveguiding walls, a groove is located between two adjacent waveguiding walls adjoining along the first direction, the groove extending along a direction which is orthogonal or substantially orthogonal to the first direction.

13. The antenna array of claim 1, wherein, as viewed along the third direction, the plurality of electrically conductive rods include an electrically conductive rod that is located between two adjacent through holes adjoining along the second direction among the plurality of through holes.

14. The antenna array of claim 2, wherein
among the plurality of waveguiding walls, a groove exists between two adjacent waveguiding walls adjoining along the first direction, the groove extending along a direction which is orthogonal or substantially orthogonal to the first direction;
as viewed along the third direction, the plurality of electrically conductive rods include an electrically conductive rod that is located between two adjacent through holes adjoining along the second direction among the plurality of through holes.

15. The antenna array of claim 1, wherein the second direction is orthogonal or substantially orthogonal to the first direction.

16. The antenna array of claim 5, wherein
the plurality of electrically conductive rods include an electrically conductive rod that is spaced away, along a direction which is orthogonal or substantially orthogonal to the first direction, from a center portion of one of the plurality of through holes as viewed along the third direction;
at least one of the plurality of waveguiding walls includes a recess on an outer peripheral surface facing toward another adjacent waveguiding wall adjoining along the second direction;
the second direction is orthogonal or substantially orthogonal to the first direction; and
one of the plurality of electrically conductive rods adjoins the recess; and
among the plurality of waveguiding walls, a groove is located between two adjacent waveguiding walls adjoining along the first direction, the groove extending along a direction which is orthogonal or substantially orthogonal to the first direction.

17. The antenna array of claim 1, wherein
the inner surface of each of the plurality of through holes includes a protrusion;
the junction is located on the protrusion; and
the core wire or the other electrical conductor is in contact with the protrusion.

18. The antenna array of claim 12, wherein
the second direction is orthogonal or substantially orthogonal to the first direction;
the inner surface of each of the plurality of through holes includes a protrusion;
the junction is located on the protrusion; and
the core wire or the other electrical conductor is in contact with the protrusion.

19. The antenna array claim 1, wherein
the plurality of waveguiding walls are connected to the second electrically conductive surface; and
the plurality of electrically conductive rods are connected to the third electrically conductive surface.

20. The antenna array claim 3, wherein
the inner surface of each of the plurality of through holes includes a protrusion;
the junction is located on the protrusion;
the core wire or the other electrical conductor is in contact with the protrusion;
an end surface, that is closer to the first electrically conductor, of the protrusion is opposed to an end surface, that is closer to the second electrically conductor, of one of the at least one ridge;
the plurality of waveguiding walls are connected to the second electrically conductive surface; and
the plurality of electrically conductive rods are connected to the third electrically conductive surface.

21. The antenna array of claim 1, further comprising a plurality of connectors respectively mounted on the rear side of the plurality of through holes, each of the plurality of connectors including:
an internal conductor including a plug or jack shape;
a dielectric outside the internal conductor; and
an external conductor outside the dielectric; wherein
the internal conductor is connected to the junction.

22. The antenna array of claim 21, further comprising a plurality of coaxial cables respectively connected to the inner surfaces of the plurality of through holes.

23. The antenna array of claim 21, further comprising:
a plurality of connectors respectively connected to the inner surfaces of the plurality of through holes; and
a plurality of coaxial cables respectively connected to the plurality of connectors.

24. A communication system comprising:
the antenna array of claim 22; and
a communications device connected to the plurality of coaxial cables.
